(19) United States
(12) Patent Application Publication
(10) Pub. No.: US 2016/0223085 A1
(43) Pub. Date: Aug. 4, 2016

(54) METAL GASKET

(71) Applicant: Japan Metal Gasket Co., Ltd., Saitama (JP)

(72) Inventors: Takahiro YAMAZAKI, Saitama (JP); Tarou TABUCHI, Saitama (JP); Atsushi SHIMIZU, Saitama (JP); Isao NAGANO, Saitama (JP); Nobuhide KOBAYASHI, Saitama (JP); Hidetaka JYUMONJI, Saitama (JP)

(21) Appl. No.: 15/013,069

(22) Filed: Feb. 2, 2016

(30) Foreign Application Priority Data
Feb. 4, 2015 (JP) 2015-020363

(51) Int. Cl. F16J 15/08; F02F 11/00

(52) U.S. Cl. CPC F16J 15/0831; F02F 11/002

(57) ABSTRACT

Localized stress concentration is minimized in a metal gasket (1). The metal gasket (1) is configured to be interposed between fastening surfaces (8A, 16E) of component parts (3, 4), and comprises a passage hole (34) corresponding to a passage (11, 18) of the component parts opening out on the fastening surfaces, a bead (38) surrounding the passage hole in an endless manner, at least three bolt holes (35) formed outside of the bead to allow fastening bolts (40) for fastening the component parts to each other to be passed therethrough, a bolt pressure receiving region (41) being defined around each bolt hole so as to correspond to a head (40A) of the corresponding fastening bolt, a first region (42) being defined by linearly connecting the bolt pressure receiving regions of two adjoining bolt holes each other and being provided with a width equal to a diameter of the bolt pressure receiving regions, and a second region being defined as a part of the first region (42) located outside of the bead; and a through hole (36) formed in the second region (43).

### TECHNICAL FIELD

The present invention relates to a metal gasket that can be used in high temperature applications,

### BACKGROUND ART

Conventionally, the metal gasket has been used as a sealing structure for fastening surfaces or mating surfaces between a cylinder block and a cylinder head, and between a cylinder head and an exhaust manifold of an engine which are placed under high temperature conditions.

As the metal gasket thermally expands under a high temperature condition, if the two parts that interpose the metal gasket therebetween have different thermal expansion coefficients from that of the metal gasket, a stress is created in the metal gasket to such an extent that the resulting deformation may impair the sealing performance of the metal gasket. To overcome this problem, with respect to a metal gasket interposed between a cylinder head and an exhaust manifold, a proposal was made to form a through hole in each of the connecting parts positioned. between the sealing parts corresponding to the respective exhaust ports so that the connecting parts may fracture when the gasket is subjected to a significant tensile stress. See JPS62-167812U, for instance. This metal gasket consists of a single piece so that the mounting work is facilitated, and once installed in the engine, the connecting parts fracture under stress, and the sealing parts are separated from each other so that each sealing part is not interfered by a tensile stress from the adjoining sealing parts,

However, the metal gasket disclosed in JPS62-167812U does not allow the stress created in each individual sealing part which has been separated from the adjoining sealing parts to be reduced. Even after each sealing part has been separated, the sealing part is at least partly fixed to the cylinder head and the exhaust manifold by the force applied by the fastening bolts so that some stress is inevitably created in each sealing part because the thermal expansion coefficient of the metal gasket differs from those of the exhaust manifold and the cylinder head. As a result, each sealing part, in particular a bead thereof, could be distorted and/or fractured, and the designed sealing performance may not be maintained.

### BRIEF SUMMARY OF THE INVENTION

In view of such a problem of the prior art, a primary object of the present invention is to provide a metal gasket that can minimize localized concentration of stress.

To achieve such an object, the present invention provides a metal gasket (1) configured to be interposed between fastening surfaces (8A, 16E) of component parts (3, 4), and comprising a passage hole (34) corresponding to a passage (11, 18) of the component parts opening out on the fastening surfaces, a bead (38) surrounding the passage hole in an endless manner, at least three bolt holes (35) formed outside of the bead to allow fastening bolts (40) for fastening the component parts to each other to be passed therethrough, a bolt pressure receiving region (41) being defined around each bolt hole so as to correspond to a head (40A) of the corresponding fastening bolt, a first region (42) being defined by linearly connecting the bolt pressure receiving regions of two adjoining bolt holes each other and being provided with a width equal to a diameter of the bolt pressure receiving regions, a second region (43) being defined as a part of the first region (42) located outside of the head, and a through hole (36) formed in the second region (43).

Thus, even when the thermal expansion coefficient of the metal gasket may differ from those of the component parts interposing the metal gasket, and stress may be thereby created in the metal gasket, localized stress concentration can be minimized. Stress tends to concentrate in a low stiffness part of the first region located between the bolt pressure receiving regions which are constrained by the fastening bolts, but by providing the through hole in the second region and thereby reducing the stiffness of this part, the stress is spread around the through hole so that localized concentration of stress in the low stiffness part of the first region can be minimized. As a result, the distortion and fracture of the metal gasket can be effectively prevented.

In this invention, it may be arranged such that the through hole is positioned in the second region in a radially outwardly offset relationship with respect to the passage hole,

According to this arrangement, because the through hole is located remotely from the bead, even though the stiffness of the part surrounding the through hole is reduced, the stiffness of the part adjoining the bead can be maintained so that the chance of causing distortion and fracture in the bead can be minimized,

In this invention, it may be arranged such that the through hole is positioned in the second region in an offset relationship thereto toward one of the bolt pressure receiving regions along a lengthwise direction of the first region.

According to this arrangement, because the stress caused in the metal gasket owing to the difference of the thermal expansion coefficient of the metal gasket from those of the component parts interposing the metal gasket tends to concentrate in the low stiffness part of the first region, by lowering the stiffness of the part adjoining the fastening bolt which is otherwise higher than the surrounding part, the stress can be effectively distributed over a wide area so that the chance of distorting and fracturing the head of the metal gasket can be minimized.

In this invention, it may be arranged such that the metal gasket comprises a plurality of laminated conformal metallic sheets (30), each metallic sheet being provided with a projection (32) extending out of the fastening surfaces of the component parts, and the metallic sheets being joined one another at the projections, wherein the through hole is formed in a part of the second region adjoining the projections.

Because the through hole is provided in a part of the metal gasket which is given with a large width and a high stiffness owing to the provision of the projection on each metallic sheet, an unevenness in stiffness can be minimized, and concentration of stress in any localized low stiffness part can be avoided. Also, even when stress is produced around the through hole, the distortion of the affected part can be minimized.

in this invention, it may be arranged such that the first region is defined between two of the adjoining bolt holes which are spaced apart farthest.

Thus, the through hole is located in a part where a localized stress concentration tends to occur owing to the difference in the thermal expansion coefficients of the associated parts so that localized concentration of stress in this part of the metal gasket can be minimized.

In this invention, it may be arranged such that the first region is defined between two of the adjoining bolt holes which are located on either side of a part of the metal gasket defining a smallest distance between the passage hole and an adjoining outer edge (39) of the metal gasket.

According to this arrangement, the through hole is located in a part where a localized stress concentration tends to occur owing to the small width and the low stiffness thereof so that the localized concentration of stress in this part of the metal gasket can be minimized.

According to a preferred embodiment of the present invention, the metal gasket is provided with an outer profile of a substantially triangular configuration, and the bolt holes comprise three bolt holes positioned in respective corner portions of the triangular configuration.

Thus, according to the present invention, localized concentration of stress in the metal gasket can be minimized.

### BRIEF DESCRIPTION OF THE DRAWINGS

FIG. 1 is an exploded perspective view of an exhaust system of an internal combustion engine embodying the present invention;

FIG. 2 is a plan view of the metal gasket; and

FIG. 3 is a sectional view taken along III-III of FIG. 2.

### DESCRIPTION OF PREFERRED EMBODIMENTS

An embodiment of the metal gasket of the present invention as applied to the exhaust system of an internal combustion engine is described in the following with reference to the appended drawings.

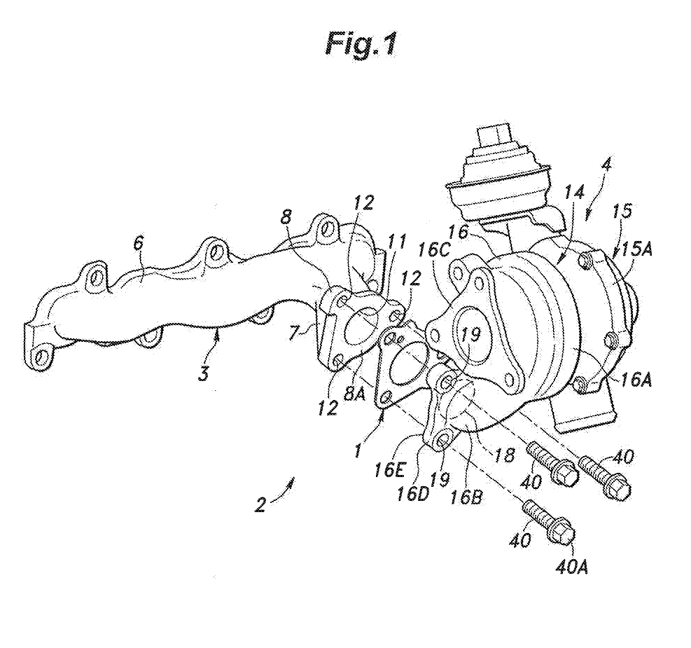

As shown in FIG. 1, the metal gasket of the illustrated embodiment is used in an exhaust system 2 of an internal combustion engine. The exhaust system 2 comprises an exhaust manifold 3 connected to a cylinder head of the engine and a turbocharger 4 connected to the downstream end of the exhaust manifold 3.

The exhaust manifold 3 includes a branch pipe portion 6 communicating with the exhaust ports formed in the cylinder head and a merging portion 7 provided at the downstream end of the branch pipe portion 6 in which individual pipes forming the branch pipe portion 6 merge into one passage. The downstream end of the merging portion 7 is formed with a manifold side flange 8 extending radially outward. The end surface of the manifold-side flange 8 defines a manifold-side fastening surface 8A perpendicular to an axial center line of the merging portion 7. To the manifold-side fastening surface 8A open out a merging passage 11 having a circular cross section and three female threaded holes 12 arranged around the merging passage 11 at a regular interval. The manifold-side fastening surface 8A is provided with a substantially triangular profile, and defines the merging passage 11 in the center and the three female threaded holes 12 at the respective corner portions.

The turbocharger 4 is provided with a turbine 14 and a compressor 15. The turbine 14 includes a turbine housing 16 and a plurality of turbine blades (not shown in the drawings) disposed in a rotatable manner in the turbine housing 16. The turbine housing 16 includes a main body 16A given with a disk shape and receiving the turbine blades in a rotatable manner therein, a turbine inlet 16B extending tangentially from a peripheral part of the main body 16A and a turbine outlet 16C extending axially from the central part of the main body 16A so that a continuous exhaust passage is defined in the turbine housing 16.

A terminal end of the turbine inlet 16B is formed with a turbine-side flange 16D extending radially outward. The end surface of the turbine-side flange 16D defines a turbine-side fastening surface 16E perpendicular to an axial line of the turbine inlet 16B. The turbine-side fastening surface 16E is substantially conformal to the manifold-side fastening surface 8A, or is provided with a substantially triangular profile. To the turbine-side fastening surface 16E open out a turbine inlet passage 18 having a circular cross section and three turbine-side bolt holes 19 arranged around the turbine inlet passage 18 at a regular interval. Each turbine-side bolt hole 19 is passed through the turbine-side flange 16D. The turbine inlet passage 18 is located substantially in the center of the turbine-side fastening surface 16E given with the triangular shape, and the turbine-side bolt holes 19 are positioned in the respective corners of the turbine-side fastening surface 16E. The turbine-side fastening surface 16E opposes the manifold-side fastening surface 8A via the metal gasket 1. In the assembled state, the merging passage 11 and the turbine inlet passage 18 communicate with each other, and the female threaded holes 12 are aligned with the corresponding turbine-side bolt holes 19.

The compressor 15 includes a compressor housing 15A and compressor blades (not shown in the drawings) rotatably disposed in the compressor housing 15A. A continuous passage is defined in the compressor housing 15A, and this passage forms a part of the intake passage communicating with the intake ports. The compressor blades are connected to the turbine blades via a connecting shaft (not shown in the drawings) so as to integrally rotate with the turbine blades.

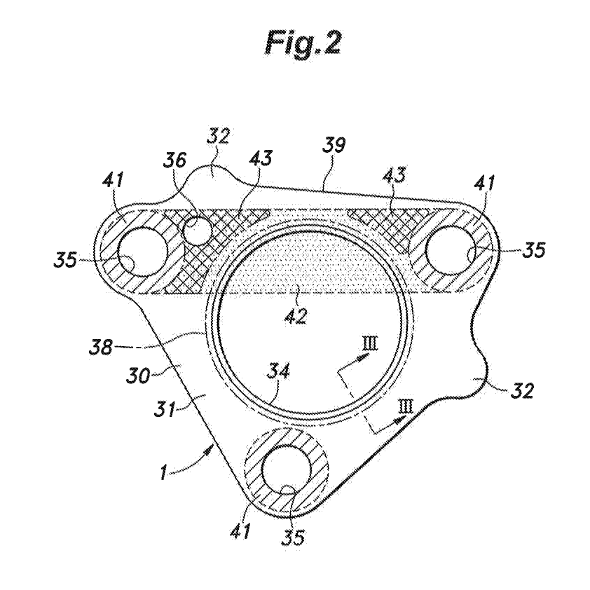

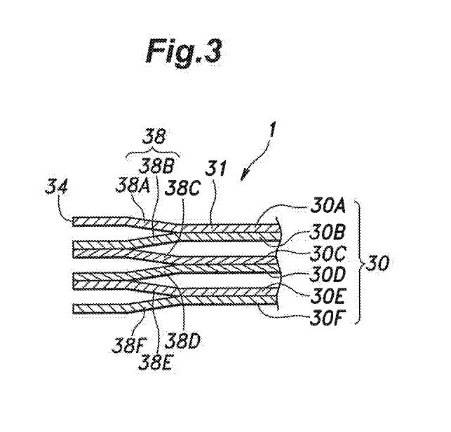

As shown in FIGS. 2 and 3, the metal gasket 1 comprises at least a single metallic plate 30. In the illustrated embodiment, the metal gasket 1 is formed by laminating a plurality of metallic plates 30 one over another. The metallic plates 30 are named as a first plate 30A, a second plate 30B, a third plate 30C, a fourth plate 30D a fifth plate 30E and a sixth plate 30F from one side to the other in that order, and are conformal to one another. Each metallic plate 30 includes a substantially triangular base portion 31 substantially conformal to the manifold-side fastening surface 8A and the turbine-side fastening surface 16E and a pair of projections 32 projecting outwardly from an outer edge 39 of the base portion 31. The metallic plates 30 are joined to one another at the projections 32. The projections 32 of one metallic plate may be joined to those of another metallic plate by any per se known method such as crimping and welding.

The metal gasket 1 is formed with a single passage hole 34, three bolt holes 35 and a single through hole 36, all passed through the thickness of the metallic plates 30. The passage hole 34 is circular, and is conformal to the merging passage 11 and the turbine inlet passage 18.

The passage hole 34 is surrounded by an annular bead 38 having an endless configuration. The bead 38 is formed by bending at least one of the metallic plates 30 in the thickness-wise direction, and ensures an adequate contact pressure to be produced between the metal gasket 1 and the manifold-side fastening surface 8A, and between the metal gasket 1 and the turbine-side fastening surface 16E. In the illustrated embodiment, the bead 38 is formed by bending all of the metallic plates 30. The first plate 30A is formed with a first half bead 38A projecting away from the second plate 30B in an annular shape surrounding the passage hole 34. The second plate 30B is formed with a second half bead 38B projecting away from the first plate 30A in an annular shape surrounding the passage hole 34. The third plate 30C is formed with a third half bead 38C projecting away from the fourth plate 30D in an annular shape surrounding the passage hole 34. The fourth plate 30D is formed with a fourth half bead 38D projecting away from the third plate 30C in an annular shape surrounding the passage hole 34. The fifth plate 30E is formed with a fifth half bead 38E projecting away from the sixth plate 30F in an annular shape surrounding the passage hole 34. The sixth plate 30F is formed with a sixth half bead 38F projecting away from the fifth plate 30E in an annular shape surrounding the passage hole 34. The first to the sixth half beads 38A to 38F are positioned in a mutually corresponding relationship in the thickness-wise direction, and jointly define the bead 38. The metal gasket 1 is allowed to intimately contact with the manifold-side fastening surface 8A and the turbine-side fastening surface 16E at this annular bead 38 so that the merging passage 11 and the turbine inlet passage 18 can be connected to each other in a gas-tight relationship.

As shown in FIG. 2, the three bolt holes 35 are arranged around and radially outwardly of the bead 38 at a circumferentially regular interval. The three bolt holes 35 are positioned so as to correspond to the female threaded holes 12 and the turbine-side bolt holes 19. The turbine 14 and the exhaust manifold 3 are connected to each other with the metal gasket 1 interposed between them by fastening bolts 40 that are passed through the turbine-side bolt holes 19 and the bolt holes 35, and threaded into the female threaded holes 12, respectively. In the metal gasket 1, an annular bolt pressure receiving region 41 is defined around each holt hole 35 as a region corresponding to the head 40A of the corresponding fastening bolt 40. Each bolt pressure receiving region 41 receives the pressure in the thickness-wise direction from the head 40A of the corresponding fastening bolt 40. In the illustrated embodiment, the fastening bolts 40 are flange bolts so that the head 40A of each fastening bolt 40 defines a circular contact surface. Each bolt pressure receiving region 41 is fixedly engaged by the manifold-side fastening surface 8A and the turbine-side fastening surface 16E such that the bolt pressure receiving region 41 moves integrally with the manifold-side fastening surface 8A and the turbine-side fastening surface 16E.

Each bolt pressure receiving region 41 is placed outwardly of the head 38 so as not to overlap with the bead 38. The outer edge 39 of the base portion 31 does not overlap with any of the bolt pressure receiving regions 41. The three bolt pressure receiving regions 41 and the bolt holes 35 are positioned at the respective corners of the base portion 31 having the substantially triangular configuration.

Because the base portion 31 is provided with the substantially triangular profile, and centrally provided with the passage hole 34, the distance between the passage hole 34 and the outer edge 39 is smallest at the central part of each side of the triangular configuration of the outer edge 39. In other words, the radial width of the metal gasket 1 about the center of the passage hole 34 is smallest at the central part of each side of the triangular configuration of the outer edge 39.

The region extending between the two adjoining bolt pressure receiving regions 41 is defined as a first region 42. The first region 42 extends linearly between the adjoining bolt pressure receiving regions 41, and has a same width as the diameter of the bolt pressure receiving regions 41. The first region 42 is defined as a region that does not overlap with any of the bolt pressure receiving regions 41, and abuts the corresponding bolt pressure receiving region 41 at each length-wise terminal end thereof. The first region 42 may overlap with any of the passage hole 34, the bead 38 and the outer edge of the base portion 31. In FIG. 2, as an example of the first region 42, the first region 42 is defined between the two bolt holes 35 that are located in an upper part in FIG. 2. The distance between these two bolt holes 35 is the longest of the distances defined between the adjoining bolt holes 35. The distance (or the width of the metal gasket 1) between the passage hole 34 and the outer edge 39 of the base portion 31 (of the metal gasket 1) is the smallest of all when the bolt holes 35 are selected from the two located in an upper part of FIG. 2.

One of the projections 32 is located between these two bolt pressure receiving regions 41, and is offset toward one of the bolt pressure receiving regions 41. In other words, the projection 32 is positioned outwardly of the first region 42 and offset toward one of the terminal ends of the first region 42.

The through hole 36 is formed in a second region 43 which is defined as a part of the first region 42 located radially outwardly of the bead 38. The through hole 36 is preferably located in a part of the second region 43 which is radially outwardly offset about the center of the passage hole 34. The through hole 36 is preferably located in a part of the second region 43 which is offset toward one of the bolt pressure receiving regions 41 along the lengthwise direction of the first region 42. The through hole 36 is preferably located in a part of the second region 43 adjoining the projection 32. The second region 43 in the illustrated embodiment consists of two parts that are separated by the passage hole 34, but may also consist of a single integral region.

The through hole 36 may be provided with any cross sectional shape such as circular, elliptic, track and polygonal (such as triangular and rectangular) shapes. In the illustrated embodiment, the cross sectional shape of the through hole 36 is circular.

The effect of the metal gasket of the illustrated embodiment is discussed in the following. By threading the fastening bolts 40 into the respective female threaded holes 12, the metal gasket 1 is interposed between the manifold-side fastening surface 8A and the turbine-side fastening surface 16E at the base portion 31. The projections 32 are positioned externally of the manifold-side fastening surface 8A and the turbine-side fastening surface 16E. The metal gasket 1 achieves a line contact with the manifold-side fastening surface 8A and the turbine-side fastening surface 16E at the bead 38, and connects the merging passage 11 and the turbine inlet passage 18 with each other via the passage hole 34 in a gas tight manner.

When the engine is in operation, exhaust gas of a high temperature is passed through the exhaust manifold 3 and the turbine 14 so that the exhaust manifold 3, the metal gasket 1 and the turbine 14 are heated. When the linear thermal expansion coefficients of the exhaust manifold 3, the metal gasket 1 and the turbine 14 differ from one another, because the bolt pressure receiving regions 41 are constrained between the manifold-side fastening surface 8A and the turbine-side fastening surface 16E, tensile or compressive stress is created in the metal gasket 1. This stress is particularly pronounced in the region located between the adjoining bolt pressure receiving regions 41 or in the first region 42. In particular, in the lengthwise central part of each first region 42, because the width (the distance between the peripheral edge of the passage hole 34 and the outer edge 39) of the metal gasket 1 is narrower than other parts, and therefore the stiffness of this part is reduced, the stress tends to concentrate in this area.

In the metal gasket 1 of the illustrated embodiment, because the through hole 36 is provided in the second region 43 which is located in a part of the first region 42 located outwardly of the bead 38, the stiffness of the area surrounding the through hole 36 is reduced so that the stress is favorably spread around the through hole 36. As a result, localized concentration of stress in a length-wise central part of the first region 42 can be reduced so that distortion, collapsing and/or fracture of this part can be minimized. Also, because the through hole 36 is located outwardly of the bead 38, the through hole 36 does not adversely affect the sealing performance of the bead 38.

Because the through hole 36 is located in a part of the second region 43 radially outwardly offset about the center of the passage hole 34, a significant distance is ensured between the through hole 36 and the bead 38 so that the influences of the stress caused by the presence of the through hole 36 on the bead 38 is minimized, and the distortion of the bead 38 is minimized. Thereby, the impairment of the sealing performance can be avoided.

Because the through hole 36 is located in a part of the second region 43 which is offset toward one of the bolt pressure receiving regions 41 along the lengthwise direction of the first region 42 away from the central part of the first region 42, the variation in stiffness within the first region 42 is mitigated so that concentration of stress in a lengthwise central part of the first region 42 can be minimized. The parts of the metal gasket 1 where the bolt pressure receiving regions 41 are located are provided with a relatively large width, and therefore have a relatively high stiffness, whereas the central part of the first region 42 along the lengthwise direction thereof is provided with a relatively small width, and therefore has a relatively low stiffness. Therefore, a stress concentration tends to occur in the central part of the first region 42 along the lengthwise direction thereof, but owing to the provision of the through hole 36, the variation in stiffness is mitigated, and the stress concentration can be minimized. Also, because the part where the through hole 36 is located has a relatively high stiffness, even when a stress is created around the through hole 36, the deformation of this part can be minimized.

Because the through hole 36 is formed in a part of the second region 43 adjoining the projection 32, the variation in stiffness in the first region 42 is mitigated, and concentration of stress in the central part of the first region 42 along the lengthwise direction thereof can he avoided. The part of the metal gasket 1 where the projection 32 is located has a relatively large width and a high stiffness, whereas the central part of the first region 42 along the lengthwise direction thereof has a relatively small width and a low stiffness. Therefore, concentration of stress which otherwise could occur in the central part of the first region 42 along the lengthwise direction of the first region 42 can be minimized owing to the reduction in the variation in stiffness in the first region 42.

The through hole 36 is located in the second region 43 defined between the two bolt holes 35 (the two upper bolt holes 35 in FIG. 2) which are spaced apart farthest. When heated, the part of the metal gasket 1 located between the adjoining bolt holes 35 that are more spaced apart than any other pair of adjoining bolt holes 35 demonstrates the greatest expansion or contraction relative to the manifold-side fastening surface 8A and the turbine-side fastening surface 16E, and hence is most likely to experience a concentration of stress. By providing the through hole 36 in this part, such a localized stress concentration can be minimized.

The through hole 36 is located in the second region 43 defined between the two bolt holes 35 (the two upper bolt holes 35 in FIG. 2) which are located on either side of the part where the distance (the width of the metal gasket 1) between the passage hole 34 and the outer edge 39 is the smallest. As the narrow part of the metal gasket 1 is provided with a low stiffness, a stress concentration tends to occur in such a part. Therefore, by providing the through hole 36 in such a part, the localized stress concentration can be minimized.

Because the through hole 36 consists of a circular hole, a relatively uniform stress distribution is produced around the through hole 36 so that localized deformation can be avoided.

The present invention has been described in terms of a specific embodiment, but the present invention is not limited by such an embodiment. In the foregoing embodiment, in a metal gasket 1 having three bolt holes 35, a single through hole 36 was provided between a selected pair of bolt holes 35, but two or more through holes 36 may also be formed. It is also possible to define a second region 43 between any other pair of adjoining bolt holes 35, and form one or more through holes 36 in the second region 43.

In an alternate embodiment, four or more bolt holes 35 are provided, and one or more through holes 36 are provided in a second region 43 defined between a freely selected pair of adjoining bolt holes 35.

The fastening bolts 40 consisted of flange bolts in the foregoing embodiment, but may also consist of any other per se known bolts such as hex bolts. In such a case, a circular washer may be interposed between the head 40A and the turbine-side flange 16D.

The foregoing embodiment was directed to a metal gasket 1 interposed in the fastening part between the exhaust manifold 3 and the turbine 14 of the turbocharger 4, but the metal gasket 1 of the present invention can be applied to other applications for high temperature environments. For instance, the metal gasket of the present invention can be used in the fastening part between a cylinder block and a cylinder head, the fastening part between a cylinder head and an exhaust manifold and the fastening part between an exhaust manifold and a catalytic converter.

### GLOSSARY OF TERMS

1 metal gasket
3 exhaust manifold.
4 turbocharger
8A manifold-side fastening surface
11 merging passage
12 female threaded hole
14 turbine
16B turbine inlet
16E turbine-side fastening surface
18 turbine inlet passage
19 turbine-side bolt hole
30A-30F first to sixth plates
31 base portion
32 projection
34 passage hole
35 bolt hole
36 through hole
38 bead
38A-38F first to sixth half beads
39 outer edge
40 fastening bolt
40A head
41 bolt pressure receiving region
42 first region
43 second region

1. A metal gasket configured to be interposed between fastening surfaces of component parts, the metal gasket comprising:
a passage hole corresponding to a passage of the component parts opening out on the fastening surfaces;
a bead surrounding the passage hole in an endless manner;
at least three bolt holes formed outside of the bead to allow fastening bolts for fastening the component parts to each other to be passed therethrough, a bolt pressure receiving region being defined around each bolt hole so as to correspond to a head of the corresponding fastening bolt, a first region being defined by linearly connecting the bolt pressure receiving regions of two adjoining bolt holes each other and being provided with a width equal to a diameter of the bolt pressure receiving regions, and a second region being defined as a part of the first region located outside of the bead; and
a through hole formed in the second region.

2. The metal gasket according to claim 1, wherein the through hole is positioned in the second region in a radially outwardly offset relationship with respect to the passage hole.

3. The metal gasket according to claim 1, wherein the through hole is positioned in the second region in an offset relationship thereto toward one of the bolt pressure receiving regions along a lengthwise direction of the first region.

4. The metal gasket according to claim 1, wherein the metal gasket comprises a plurality of laminated conformal metallic sheets, each metallic sheet being provided with a projection extending out of the fastening surfaces of the component parts, and the metallic sheets being joined one another at the projections; and
wherein the through hole is formed in a part of the second region adjoining the projections.

5. The metal gasket according to claim 1, wherein the first region is defined between two of the adjoining bolt holes which are spaced apart farthest.

6. The metal gasket according to claim 1, wherein the first region is defined between two of the adjoining bolt holes which are located on either side of a part of the metal gasket defining a smallest distance between the passage hole and an adjoining outer edge of the metal gasket.

7. The metal gasket according to claim 1, wherein the metal gasket is provided with an outer profile of a substantially triangular configuration, and the bolt holes comprise three bolt holes positioned in respective corner portions of the triangular configuration.

8. The metal gasket according to claim 1, wherein the metal gasket comprises a plurality of laminated conformal metallic sheets, each metallic sheet being provided with a projection extending out of the fastening surfaces of the component parts, and the metallic sheets being joined one another at the projections; and
wherein the projection of each metallic sheet is positioned in an offset relationship along a lengthwise direction of the first region toward one of the bolt pressure receiving regions, and the through hole is formed in a part of the second region adjoining the projections.

9. The metal gasket according to claim 8, wherein the through hole is positioned in the second region in a radially outwardly offset relationship with respect to the passage hole.
